(19) United States
(12) Patent Application Publication
(10) Pub. No.: US 2013/0339081 A1
(43) Pub. Date: Dec. 19, 2013

(54) RISK ANALYSIS SYSTEM AND RISK ANALYSIS METHOD

(71) Applicant: Yoshiharu Maeno, Tokyo (JP)

(72) Inventor: Yoshiharu Maeno, Tokyo (JP)

(73) Assignee: NEC Corporation

(21) Appl. No.: 13/979,810

(22) PCT Filed: Dec. 16, 2011
(86) PCT No.: PCT/JP11/79240

§ 371 Date: Jul. 15, 2013

(30) Foreign Application Priority Data
Jan. 24, 2011 (JP) 2011-012303

(51) Int. Cl. G06Q 10/06

(52) U.S. Cl. CPC G06Q 10/0635
USPC 705/7.28

(57) ABSTRACT

A risk indicating a degree of impact of a change in a production volume of one industrial sector on a production volume of another industrial sector at an arbitrary time is analyzed. Input coefficients among a plurality of interdependent industrial sectors are stored in an input-output table storage unit; an initial production volume of each industrial sector at an initial time is stored in an initial production volume storage unit; based on the input coefficients and the initial production volumes, a plurality of sample values of an accumulated production volume of each industrial sector from the initial time to a predetermined analysis time is generated such that there is a variation in the plurality of sample values; the plurality of generated sample values is stored in a sample storage unit; based on the plurality of sample values stored in the sample storage unit, a risk of a change in an accumulated production volume at the analysis time in at least one industrial sector that is subject to analysis among the plurality of industrial sectors is analyzed; and an analysis result of the risk is outputted.

### BACKGROUND

The present invention relates to a risk analysis system and a risk analysis method.

Input-output tables are known as indicators for analyzing production by interdependent corporations. An input-output table is a macroscopic economic indicator devised by Wassily Leontief, an economist of the former Soviet Union, wherein transaction amounts between industrial sectors are represented in a matrix format. In addition, an input-output table can be described as a representation of a magnitude of a spillover effect of production by one industrial sector on production by another industrial sector. The magnitude of the spillover effect is referred to as an input coefficient and is useful as basic data for assessing a life cycle of a product. In Japan, an input-output table is jointly created every five years by government ministries with the Ministry of Internal Affairs and Communications leading the joint effort. For example, the 2005 Input-Output Table shows that in order to achieve production of 1 unit, the agriculture, forestry and fisheries industry needs to purchase 0.124901 units of raw material from the agriculture, forestry and fisheries industry, purchase 0.000048 units of raw material from the mining industry, and purchase 0.094618 units of raw material from the food and beverage industry.

For example, Patent Documents 1 to 5 disclose examples of methods of analyzing production by interdependent corporations through the use of such an input-output table.

Patent Document 1 discloses a method in which, by specifying a recycling mode for each material constituting a product that is an analysis subject in each product-specific recycling stage, a magnitude of environmental load is determined using discharge rates calculated based on an input-output table.

In addition, Patent Document 2 discloses a method in which, when analyzing interdependency among a plurality of divisions of a corporation, an inverse matrix coefficient used to calculate sales, operating profit, and variable cost when given sales by each division to outside the corporation is calculated and an input-output table of the divisions is outputted.

Furthermore, Patent Document 3 discloses a product design support method in which, based on an input-output table representing transaction amounts related to parts and materials and an environmental load database, an environmental load is predicted in advance during a design stage of a product and a magnitude of the environmental load is calculated in a swift an easy manner.

In addition, Patent Document 4 discloses a method of evaluating a magnitude of an environmental load which enables a comprehensive evaluation from the production to disposal of a product to be made efficiently and with high accuracy and design of the product to be performed in consideration of a disposal process even in the case of complicated products that are constituted by a wide variety of parts.

Furthermore, Patent Document 5 discloses a method in which data of a life cycle of a product is managed in association with an identification number and an environmental load for each production process and only minimum necessary data is disclosed to other processes utilizing the product in order to commonly manage information of an environmental load of a life cycle of a product across all production processes.

FIG. 12 shows an example of a production analysis system which analyzes production by interdependent corporations by utilizing an input-output table. A production analysis system 100 comprises an input-output table input unit 110, an initial production volume input unit 112, a spillover effect calculation unit 114, and an ultimate production volume display unit 116. An input coefficient of the input-output table described above is supplied to the system 100 via the input-output table input unit 112. The initial production volume input unit 112 accepts a production volume of each industrial sector that is subject to analysis from a user of the system. The spillover effect calculation unit 114 calculates ultimate production volumes based on the input coefficient and initial production volumes, and outputs an ultimate production volume for each industrial sector. When analyzing production by interdependent corporations or, in other words, when analyzing a supply chain, a calculated result can be applied without modification if it is assumed that production by one corporation spills over to production by another corporation in accordance with an input coefficient between industrial sectors to which the corporations respectively belong. Therefore, with respect to a spillover from the production by one industrial sector to the production by another industrial sector, the production analysis system 100 enables an assessment to be made on an average magnitude of the spillover after a sufficient period of time has lapsed.

Moreover, a detailed description of an example of a specific calculation method employed by the spillover effect calculation unit 114 is given in Chapter 5 “Coefficients For Input-Output Analysis And Computation Methods” and Chapter 6 “Input-Output Analysis Methods” of “2005 Input-Output Tables for Japan: Explanatory Notes”, compiled by the Ministry of Internal Affairs and Communications in March 2009.
Patent Document 1: Patent Publication JP-A-2005-301867
Patent Document 2: Patent Publication JP-A-2010-224769
Patent Document 3: Patent Publication JP-A-2004-334272
Patent Document 4: Patent Publication JP-A-2002-259628
Patent Document 5: Patent Publication JP-A-11-161709

Since amounts of individual transactions vary from one corporation to another even in the same industrial sector and also vary at different periods even with the same corporation, a coefficient described in the input-output table merely represents an average value. Therefore, simply using the coefficient described in the input-output table does not allow analysis incorporating microscopic differences to be conducted such as an analysis of an impact of production by one industrial sector to another industrial sector at an arbitrary time from immediately after the production. For example, with the production analysis system 100 described above, there is no way to assess a degree of deviation (variation) of a spillover from an average magnitude in a best-case scenario or a worst-case scenario at an arbitrary time from immediately after production by an industrial sector.

### SUMMARY

The present invention has been made in consideration of such circumstances and an object thereof is to analyze a risk indicating a degree of impact of a change in production by one industrial sector to production by another industrial sector at an arbitrary time.

A risk analysis system according to an aspect of the present invention includes: an input-output table storage unit configured to store input coefficients among a plurality of interdependent industrial sectors; an initial production volume storage unit configured to store an initial production volume of each industrial sector at an initial time; a sample generation unit configured to generate a plurality of sample values of an accumulated production volume of each industrial sector from the initial time to a predetermined analysis time such that there is a variation in the plurality of sample values, based on the input coefficients and the initial production volumes; a sample storage unit configured to store the plurality of sample values generated by the sample generation unit; a risk analysis unit configured to analyze a risk of a change in an accumulated production volume at the analysis time in at least one industrial sector that is subject to analysis among the plurality of industrial sectors, based on the plurality of sample values stored in the sample storage unit; and an analysis result output unit configured to output an analysis result of the risk analysis unit.

Moreover, as used in the present invention, the term “unit” not only signifies physical means but also includes cases where functions of the “unit” are realized by software. In addition, functions of one “unit” or device may be realized by two or more physical means or devices, and functions of two or more “units” or devices may be realized by one physical means or device.

According to the present invention, a risk indicating a degree of impact of a change in a production volume of one industrial sector to a production volume of another industrial sector at an arbitrary time can be analyzed.

### DESCRIPTION OF DRAWINGS

FIG. 1 is a diagram showing a configuration of a risk analysis system according to a present embodiment;

FIG. 2 is a diagram showing an example of an input-output table;

FIG. 3 is a diagram showing an example of an initial production volume management table;

FIG. 4 is a diagram showing an example of an accumulated production volume management table;

FIG. 5 is a diagram showing an example of a sample management table;

FIG. 6 is a flow chart showing an example of a risk analysis process;

FIG. 7 is a diagram showing a specific example of an input-output table;

FIG. 8 is a diagram showing a specific example of an initial production volume management table;

FIG. 9 is a diagram showing an example of an accumulated production volume management table in an initialized state;

FIG. 10 is a diagram showing a specific example of an accumulated production volume management table;

FIG. 11 is a diagram showing a specific example of a sample management table; and

FIG. 12 is a diagram showing an example of a production analysis system.

### DETAILED DESCRIPTION

Hereinafter, an embodiment of the present invention will be described with reference to the drawings.

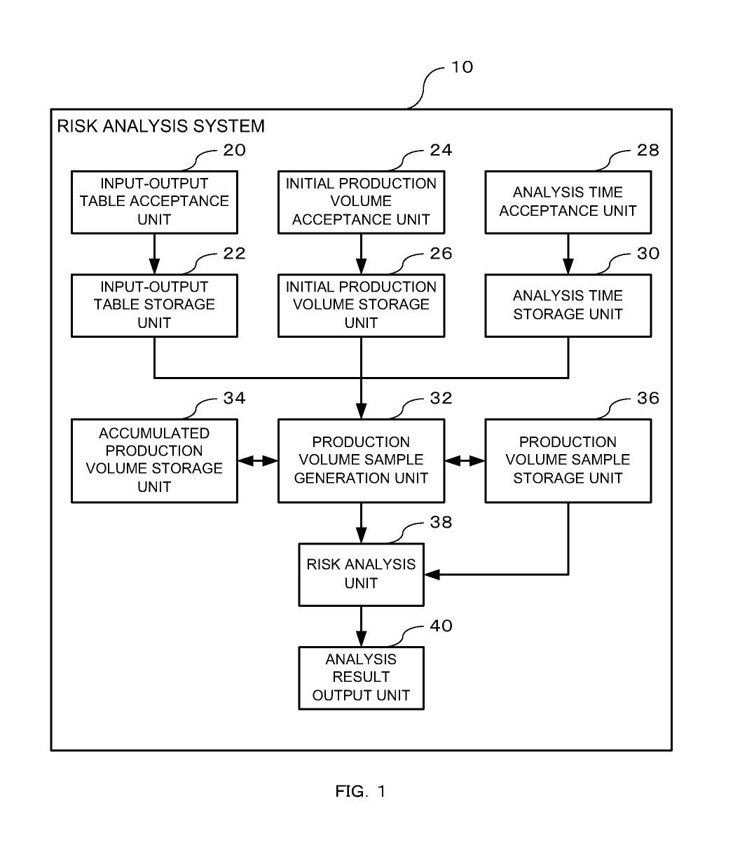

FIG. 1 is a diagram showing a configuration of a risk analysis system according to the present embodiment. The risk analysis system 10 is a system which analyzes a risk of a change in production volume between interdependent industrial sectors. For example, the risk analysis system 10 can be configured using an information processing device such as a server. Alternatively, the risk analysis system 10 may be configured using a plurality of information processing devices.

As shown in FIG. 1, the risk analysis system 10 is configured so as to comprise an input-output table acceptance unit 20, an input-output table storage unit 22, an initial production volume acceptance unit 24, an initial production volume storage unit 26, an analysis time acceptance unit 28, an analysis time storage unit 30, a production volume sample generation unit 32, an accumulated production volume storage unit 34, a production volume sample storage unit 36, a risk analysis unit 38, and an analysis result output unit 40. Moreover, the input-output table storage unit 22, the initial production volume storage unit 26, the analysis time storage unit 30, the accumulated production volume storage unit 34, and the production volume sample storage unit 36 can be realized using, for example, a storage area of a memory, a storage device, or the like in an information processing device. In addition, the input-output table acceptance unit 20, the initial production volume acceptance unit 24, the analysis time acceptance unit 28, the production volume sample generation unit 32, the risk analysis unit 38, and the analysis result output unit 40 can be realized by having a processor execute a program stored in a memory in the information processing device.

The input-output table acceptance unit 20 accepts an input-output table necessary for risk analysis and stores the input-output table in the input-output table storage unit 22. For example, the input-output table acceptance unit 20 can accept an input-output table inputted by a user of the system via an input I/F of an information processing device or can accept an input-output table from another system.

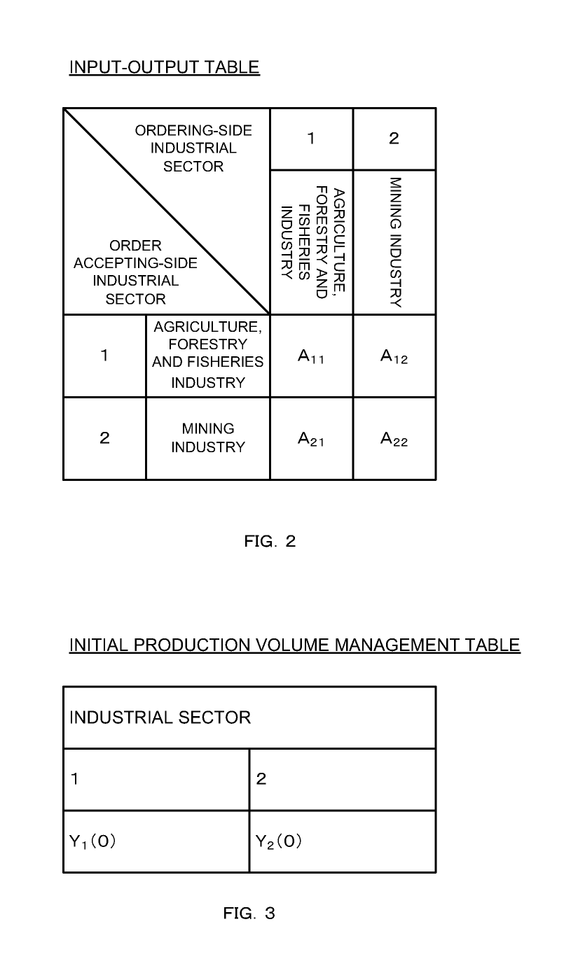

In the input-output table, an input coefficient is set for each pair consisting of an ordering-side industrial sector and an order accepting-side industrial sector of a transaction. FIG. 2 is a diagram showing an example of an input-output table stored in the input-output table storage unit 22. In the example shown in FIG. 2, a matrix consisting of identifiers indicating industrial sectors (industrial sector identifiers) is formed in the input-output table, and input coefficients are set to each element of the matrix. For example, an identifier “1” denotes the agriculture, forestry and fisheries industry and an identifier “2” denotes the mining industry. In addition, the identifiers are assigned according to a predetermined rule and non-integral values may be used instead. In FIG. 2, an input coefficient Aⱼᵢ represents a unit of raw materials that needs to be inputted from an industrial sector “j” for an industrial sector “i” to produce 1 unit. For example, an input coefficient A₁₁ means that an industrial sector “1” needs to purchase A₁₁ units of raw material from the industrial sector “1” in order to produce 1 unit. In addition, an input coefficient A₂₁ means that the industrial sector “1” needs to purchase A₂₁ units of raw material from an industrial sector “2” in order to produce 1 unit. Moreover, while a 2×2 matrix is shown in FIG. 2 as an example where there are two industrial sectors, the greater the number of industrial sectors, the larger the matrix shown in the input-output table. In addition, the number of industrial sectors is set in advance to, for example, 13, 34, or 108, and an input-output table with a size corresponding to the number is stored in the input-output table storage unit 22.

The initial production volume acceptance unit 24 accepts an initial production volume management table necessary for risk analysis and stores the initial production volume management table in the initial production volume storage unit 26. For example, the initial production volume acceptance unit 24 can accept an initial production volume inputted by the user of the system via an input I/F of an information processing device. The initial production volume is a condition for analyzing risk and is specified by the user of the system. For example, when analyzing risk in a case where an initial production volume of the risk analysis unit “1” is 10 units, “10” is inputted as the initial production volume. In addition, when comparing magnitudes of risk by varying the initial production volume, the inputted initial production volume is varied.

An initial production volume of each industrial sector is set in the initial production volume management table. FIG. 3 is a diagram showing an example of an initial production volume management table stored in the initial production volume storage unit 26. In the example shown in FIG. 3, an initial production volume of each industrial sector is set in the initial production volume management table. In FIG. 3, an initial production volume Yᵢ(0) represents an initial production volume of the industrial sector “i”. Moreover, while an initial production volume management table in which initial production volumes of two industrial sectors are set is shown in FIG. 3, the greater the number of industrial sectors, the greater the size of the initial production volume management table stored in the initial production volume storage unit 26.

The analysis time acceptance unit 28 accepts an analysis time necessary for risk analysis and stores the analysis time in the analysis time storage unit 30. In this case, an analysis time refers to a time where risk analysis is performed after start of initial production. Since the analysis time stored in the analysis time storage unit 30 is a single value, the analysis time is not necessarily stored in a table format. The analysis time is a condition for analyzing risk and is specified by the user of the system. For example, with the risk analysis system 10, time may have an initial value of “0” and may be incremented by “1”. One unit of time can be set to a period set in advance such as five days. In this case, for example, when analyzing risk for the 10th day after the start of initial production, “2” is inputted as the analysis time. In addition, when comparing magnitudes of risk by varying the analysis time, the inputted analysis time is varied.

The production volume sample generation unit 32 calculates an accumulated production volume at the analysis time while taking a variation of each transaction into consideration based on the input-output table, the initial production volume management table, and the analysis time. In addition, the production volume sample generation unit 32 stores sample data in which the calculated accumulated production volume is set in the production volume sample storage unit 36. Furthermore, the production volume sample generation unit 32 repetitively executes calculation of an accumulated production volume until the number of pieces of sample data necessary for analyzing risk is accumulated. Moreover, it is assumed that a lower limit (threshold) of the number of pieces of sample data necessary for analyzing risk has been set in advance.

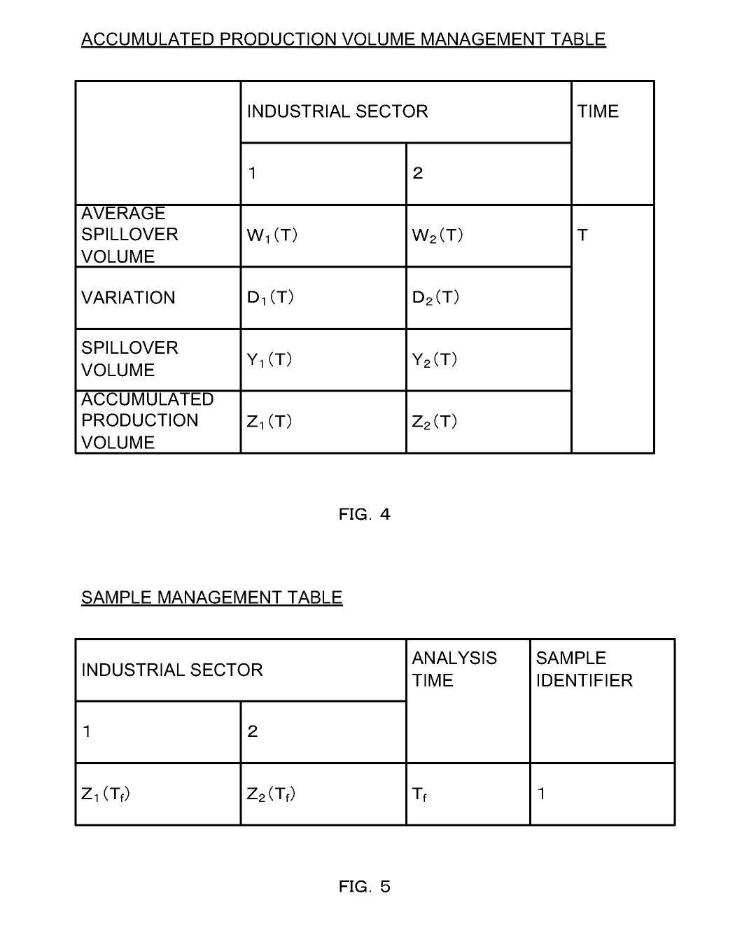

FIG. 4 is a diagram showing an example of an accumulated production volume management table which is generated by the production volume sample generation unit 32 and which is stored in the accumulated production volume storage unit 34. In the example shown in FIG. 4, an average spillover volume, a variation, a spillover volume, and an accumulated production volume at a given time are set for each industrial sector in the accumulated production volume management table.

An average spillover volume (average production volume) represents an average of spillover volumes (production volumes) at a given time of an industrial sector, and is calculated based on an input coefficient and a spillover volume of each industrial sector at an immediately previous time. For example, an average spillover volume Wᵢ(T) of the industrial sector “i” at a time “T” can be calculated according to Expression (1) below based on a spillover volume Yⱼ(T−1) of each industrial sector at a time “T−1”.

$$\begin{matrix}[ Expression 1 ] & \\ {W}_{i} ( T ) = {\sum }_{j = 1}^{2} {A}_{ji} {Y}_{j} ( T - 1 ) ( i = 1 , 2 ) & ( 1 )\end{matrix}$$

Moreover, while Expression 1 represents an example where there are two industrial sectors, the greater the number of industrial sectors, the greater the values of i and j. This also applies to the other expressions given below.

Variation is used to cause a change in a spillover volume (production volume) of each transaction and is calculated based on an input coefficient, a spillover volume of each industrial sector at an immediately previous time, and a random number. For example, a variation Dᵢ(T) representing a “deviation” from an average spillover volume of the industrial sector “i” at the time “T” can be calculated according to Expressions (2) and (3) below.

$$\begin{matrix}[ Expression 2 ] & \\ {X}_{j} ( T ) \text{∼} N ( 0 , 1 ) ( j = 1 , 2 ) & ( 2 ) \\ [ Expression 3 ] & \\ {D}_{i} ( T ) = {\sum }_{j = 1}^{2} {\{ {A}_{ji} {Y}_{j} ( T - 1 ) \}}^{θ} {X}_{j} ( T ) ( i = 1 , 2 ) & ( 3 )\end{matrix}$$

In Expression (2), N(0,1) represents a normal distribution with a median of “0” and a variance of “1” (a standard deviation of “1”), and Xⱼ(T) denotes a random number in accordance with the normal distribution. In addition, in Expression (3), an exponent θ is a value set in advance. For example, 0=0.5 can be adopted. Therefore, in transactions from the ordering-side industrial sector “j” to the order accepting-side industrial sector “i”, the variation Dᵢ(T) calculated according to Expression (3) is obtained by multiplying amplitude that is a value determined as a function of a spillover volume in accordance with each transaction from the ordering-side industrial sector “j” by a variation represented by a normal random number.

A spillover volume represents a production volume of an industrial sector at a given time and is calculated based on an average spillover volume and a variation. For example, a spillover volume Yᵢ(T) of the industrial sector “i” at the time “T” can be calculated according to Expression (4) below.

[Expression 4]

Yᵢ(T)=Wᵢ(T)+Dᵢ(T)(1,2) (4)

An accumulated production volume is an accumulation of spillover volumes (production volumes) up to a given time. For example, an accumulated production volume Zᵢ(T) of the industrial sector “i” at the time “T” can be calculated according to Expression (5) below.

$$\begin{matrix}[ Expression 5 ] & \\ {Z}_{i} ( T ) = {\sum }_{{T}^{′} = 0}^{T} {Y}_{i} ( {T}^{′} ) ( i = 1 , 2 ) & ( 5 )\end{matrix}$$

Based on such expressions, the production volume sample generation unit 32 calculates an accumulated production volume at an analysis time and stores the accumulated production volume in the sample management table storage unit 36. Moreover, since a variation for each transaction is taken into consideration when calculating a spillover volume (production volume) at each time, a variation also occurs in accumulated production volume sample values.

FIG. 5 is a diagram showing an example of a sample management table which is generated by the production volume sample generation unit 32 and which is stored in the production volume sample storage unit 36. As shown in FIG. 5, an accumulated production volume sample value Zᵢ(T_{f}) of the industrial sector “i” at an analysis time “T_{f}” is stored together with a sample identifier in the sample management table. A sample identifier is assigned to each piece of sample data so as to avoid duplicates. For example, the sample identifiers can be integer values incremented by “1”.

The risk analysis unit 38 analyzes a risk of a change in production volume in each industrial sector based on the sample data stored in the sample management table. Specific analysis examples will be described later.

The analysis result output unit 40 outputs a result of the analysis conducted by the risk analysis unit 38. Moreover, output of the analysis result can be performed by displaying on a display or by outputting data to another system.

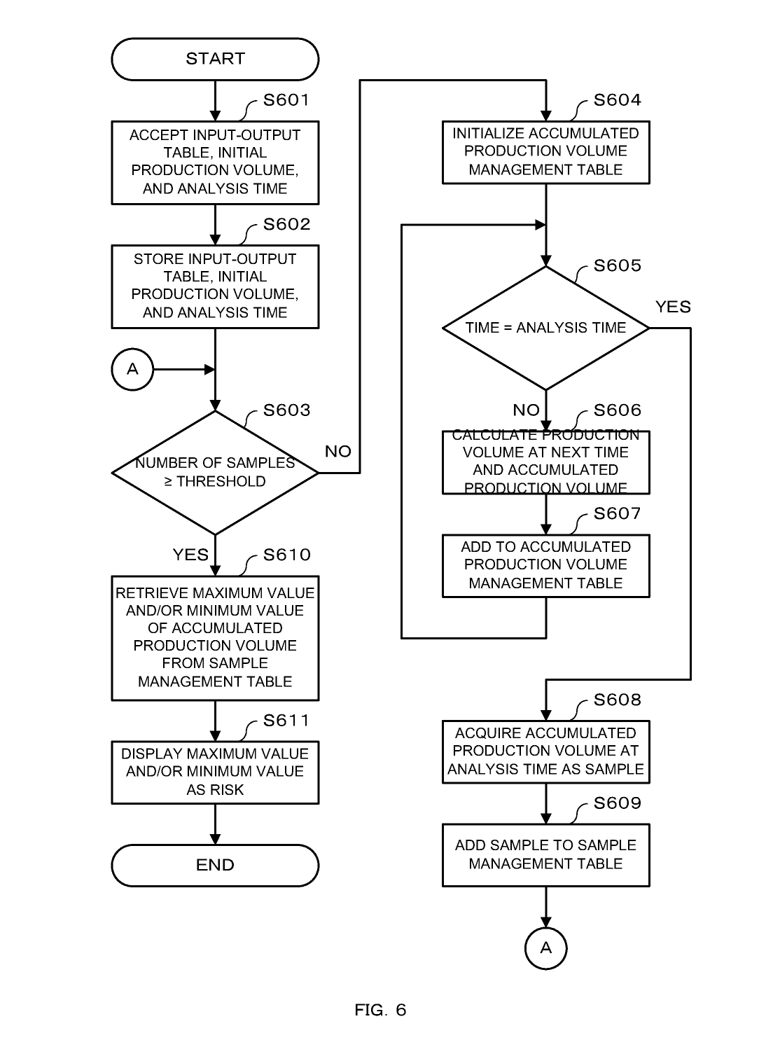

Next, a risk analysis process in the risk analysis system 10 will be described. FIG. 6 is a flow chart showing an example of the risk analysis process.

First, an input-output table, an initial production volume, and an analysis time are accepted by the input-output table acceptance unit 20, the initial production volume acceptance unit 24, and the analysis time acceptance unit 28 (S601), and stored in the input-output table storage unit 22, the initial production volume storage unit 26, and the analysis time storage unit 30 (S602).

The production volume sample generation unit 32 refers to the production volume sample storage unit 36 to check whether the number of pieces of sample data stored in the sample management table is equal to or greater than a threshold (S603). Moreover, the threshold is a lower limit of the number of pieces of sample data necessary for analyzing data and is set in advance.

When the number of pieces of sample data is lower than the threshold (NO in S603), the production volume sample generation unit 32 initializes the accumulated production volume management table stored in the accumulated production volume storage unit 34 (S604). Moreover, the production volume sample generation unit 32 initializes the time to, for example, “0” when initializing the accumulated production volume management table.

The production volume sample generation unit 32 judges whether the time has reached the analysis time (S605). If the time has not reached the analysis time (NO in S605), for example, “1” is added to the time, a spillover volume and an accumulated production volume at that time are calculated (S606), and the calculated spillover volume and accumulated production volume are added to the accumulated production volume management table stored in the accumulated production volume storage unit 34 (S607). Subsequently, the production volume sample generation unit 32 returns to the judgment of time (S605). In other words, the accumulated production volume calculation process is repetitively executed until the time reaches the analysis time.

When the time reaches the analysis time (YES in S605), the production volume sample generation unit 32 suspends addition to the accumulated production volume management table. Subsequently, the production volume sample generation unit 32 refers to the accumulated production volume management table stored in the accumulated production volume storage unit 34 and acquires the accumulated production volume at the analysis time as a sample value (S608). The production volume sample generation unit 32 adds sample data to which the sample value has been set to the sample management table in the production volume sample storage unit 36 (S609) and returns to the judgment of the number of pieces of sample data (S603). In other words, the process of generating sample data at the analysis time is repetitively executed until the number of pieces of sample data stored in the sample management table equals or exceeds the threshold.

When the number of pieces of sample data reaches the threshold (YES in S603), the risk analysis unit 38 refers to the sample management table in the production volume sample storage unit 36 and analyzes the risk of each industrial sector at the analysis time. For example, the risk analysis unit 38 retrieves a maximum value and/or a minimum value of the accumulated production volume of each industrial sector as values indicating risk from the sample management table (S610).

The analysis result output unit 40 outputs a result of the analysis conducted by the risk analysis unit 38. For example, the analysis result output unit 40 displays the maximum value and/or the minimum value of the accumulated production volume of each industrial sector retrieved by the risk analysis unit 38 (S611). The minimum value of the accumulated production volume of an industrial sector to which belongs a corporation of interest as an analysis subject can be interpreted as a risk which represents a financial and accounting impact as a production volume lower limit. In addition, the maximum value of the accumulated production volume can be interpreted as a risk which represents an environmental load as a production volume upper limit. Moreover, the maximum value and the minimum value are examples of indices that represent risk. Indices representing risk are not limited thereto and more sophisticated or complicated indices may be used instead.

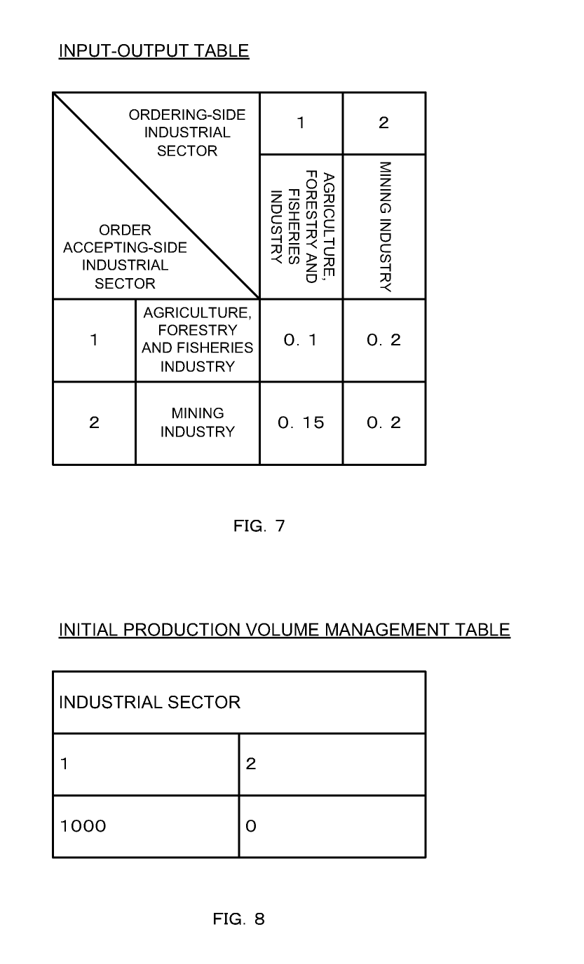

An example of the risk analysis process will now be described using a specific example. Let us assume that an input-output table shown in FIG. 7 is currently stored in the input-output table storage unit 22. In the input-output table shown in FIG. 7, for example, an input coefficient between an ordering-side industrial sector “1” and an order accepting-side industrial sector “2” is set to A₂₁=0.15. Let us also assume that an initial production volume management table shown in FIG. 8 is stored in the initial production volume storage unit 26. In the initial production volume management table shown in FIG. 8, an initial production volume of the industrial sector “1” is set to “1000” and an initial production volume of the industrial sector “2” is set to “0”. Moreover, it is assumed that “2” is set as an analysis time.

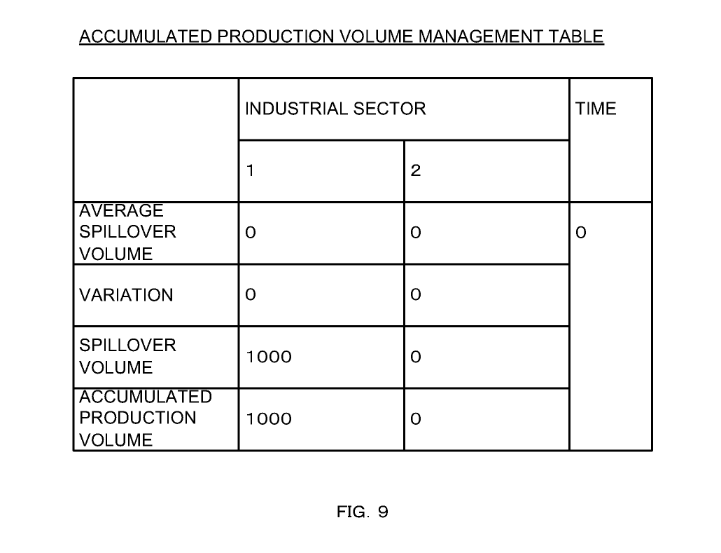

In addition, an example of an accumulated production volume management table in an initialized state is shown in FIG. 9. In the accumulated production volume management table, the initial production volume in the initial production volume management table is set as a spillover volume and an accumulated production volume for each industrial sector. Moreover, an initial value “0” is set for average spillover volume and variation.

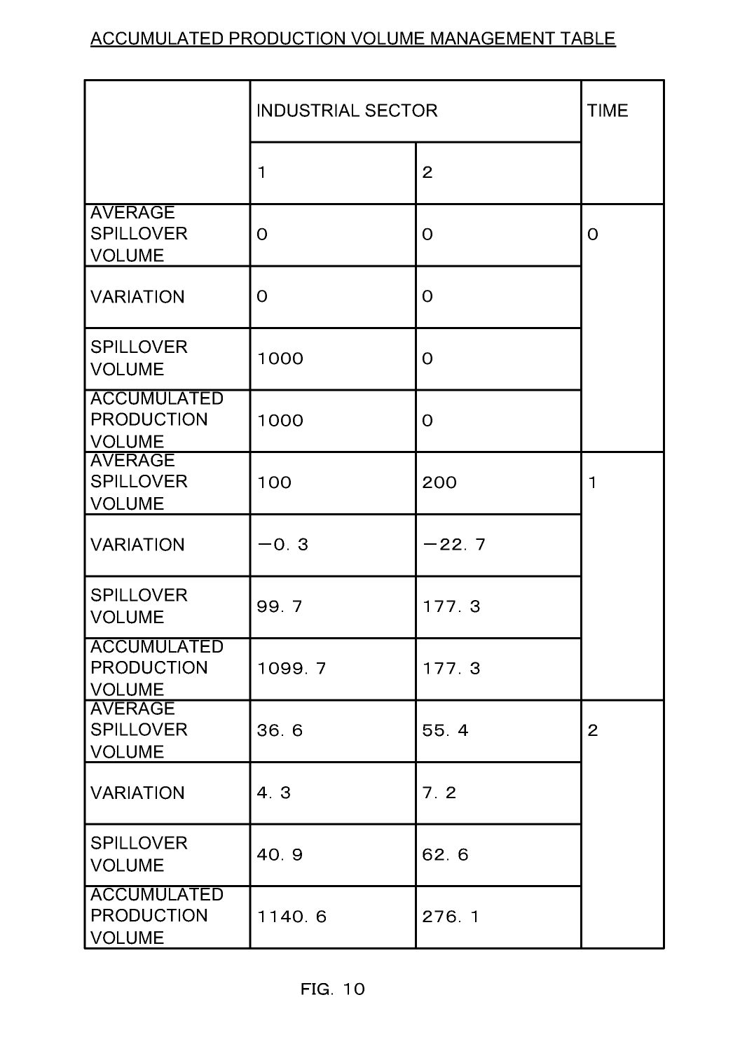

Furthermore, an example of an accumulated production volume management table at the time “2” which has been updated by the production volume sample generation unit 32 under such conditions is shown in FIG. 10. An average spillover volume, a variation, a spillover volume, and an accumulated production volume set in the accumulated production volume management table have been calculated according to Expressions (1) to (5) based on the input-output table shown in FIG. 7 and the initial production volume management table shown in FIG. 8. As shown in FIG. 10, an accumulated production volume up to the time “2” that is the analysis time is calculated.

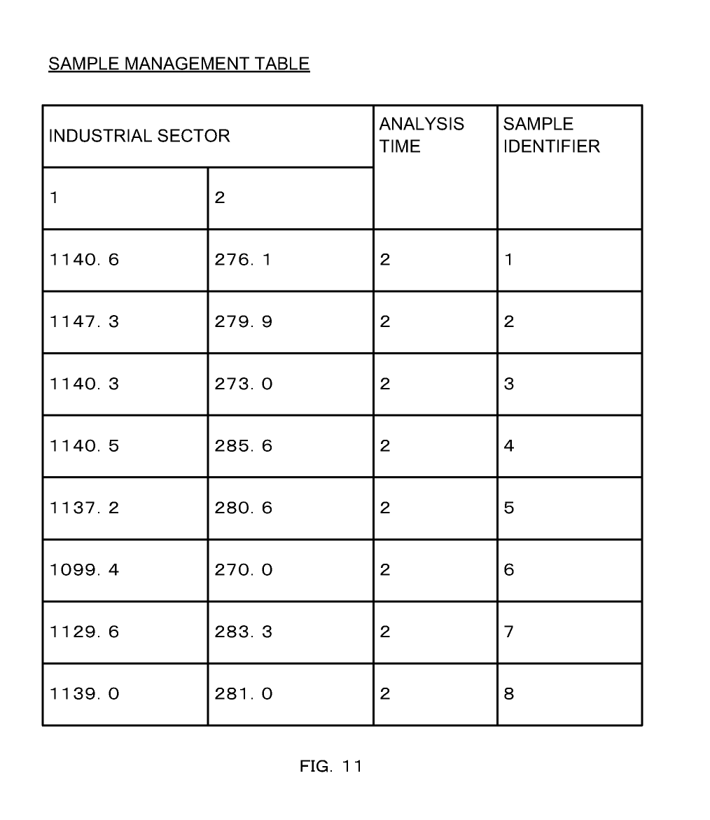

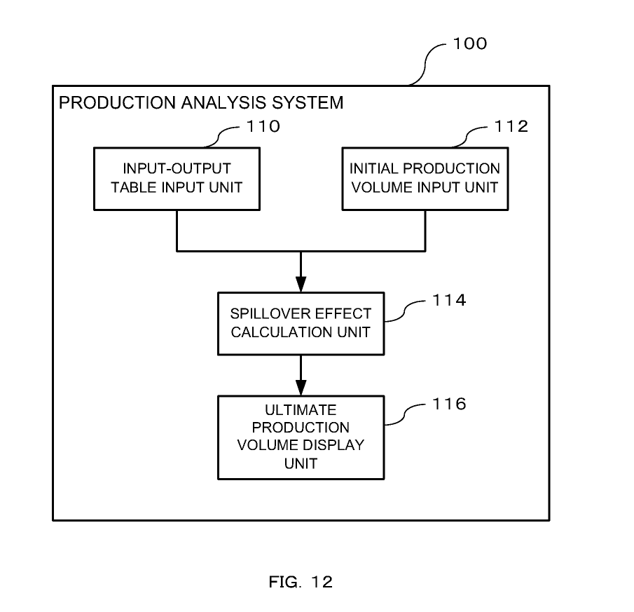

In addition, FIG. 11 shows an example of a sample management table. As shown in FIG. 11, the accumulated production volume at the time “2” in the accumulated production volume management table shown in FIG. 10 is set to sample data that is denoted by a sample identifier “1”. In other words, an accumulated production volume “1140.6” of the industrial sector “1” and an accumulated production volume “276.1” of the industrial sector “2” are set to the sample data. Furthermore, in addition to the above, sample data denoted by sample identifiers “2” to “8” are stored in the sample management table shown in FIG. 11.

Now, assuming that a lower limit of the number of pieces of sample data necessary for risk analysis is “8”, the risk analysis unit 38 can conduct risk analysis based on the sample management table shown in FIG. 11. For example, when a maximum value and a minimum value of the accumulated production volume are used as risk indices, the risk analysis unit 38 refers to the sample management table in FIG. 11 and acquires “1147.3” that is set to the sample data denoted by the sample identifier “2” as the maximum value of the accumulated production volume of the industrial sector “1”. In addition, the risk analysis unit 38 acquires “1099.4” that is set to the sample data denoted by the sample identifier “6” as the minimum value of the accumulated production volume of the industrial sector “1”. In a similar manner, for the industrial sector “2”, “285.6” that is set to the sample data denoted by the sample identifier “4” is acquired as the maximum value of the accumulated production volume and “270.0” that is set to the sample data denoted by the sample identifier “6” is acquired as the minimum value of the accumulated production volume. The analysis result output unit 40 outputs the maximum value and the minimum value of the accumulated production volume of each industrial sector acquired in this manner as a risk analysis result.

In addition, the risk analysis unit 38 is not only capable of simply analyzing a risk of a change in the accumulated production volume for each industrial sector but is also capable of detecting a risk of correlation between industrial sectors. For example, by retrieving accumulated production volumes of other industrial sectors when the accumulated production volume of an industrial sector equals a maximum value or a minimum value from the sample management table, the risk analysis unit 38 can detect a risk of correlation between the industrial sectors. For example, the accumulated production volume of the industrial sector “2” is “279.9” when the accumulated production volume of the industrial sector “1” assumes a maximum value of “1147.3”. This value conceivably represents a risk attributable to a correlation between the industrial sector “1” and the industrial sector “2”. In addition, the accumulated production volume of the industrial sector “2” is “270.0” when the accumulated production volume of the industrial sector “1” assumes a minimum value of “1099.4”. This is equivalent to a minimum value of the accumulated production volume of the industrial sector “2”. Therefore, risks of the production volume of the industrial sector “2” decreasing are all conceivably risks attributable to a correlation between the industrial sector “1” and the industrial sector “2”.

This concludes the description of the present embodiment. With the risk analysis system 10 according to the present embodiment, a risk indicating a degree of impact of a change in a production volume of one industrial sector to a production volume of another industrial sector at an arbitrary time can be analyzed. For example, a degree of deviation (variation) of a potential spillover from an average production volume in a best-case scenario or a worst-case scenario at an arbitrary time from immediately after production by an industrial sector can be assessed.

It should be noted that the present embodiment is for facilitating understanding of the present invention and is not for limiting the interpretation of the present invention. Various modifications and changes may be made to the present invention without departing from the spirit and scope thereof, and equivalents are to be included in the present invention.

The present application claims priority on the basis of Japanese Patent Application No. 2011-012303 filed on Jan. 24, 2011, the entire contents of which are incorporated herein by reference.

While the present invention has been described with reference to an embodiment, the present invention is not intended to limit the embodiment described above. Various modifications to configurations and details of the present invention will occur to those skilled in the art without departing from the scope of the present invention.

A part of or all of the present embodiment may also be described as, but not limited to, the appendices provided below.

(Appendix 1) A risk analysis system comprising: an input-output table storage unit configured to store input coefficients among a plurality of interdependent industrial sectors; an initial production volume storage unit configured to store an initial production volume of each industrial sector at an initial time; a sample generation unit configured to generate a plurality of sample values of an accumulated production volume of each industrial sector from the initial time to a predetermined analysis time such that there is a variation in the plurality of sample values, based on the input coefficients and the initial production volumes; a sample storage unit configured to store the plurality of sample values generated by the sample generation unit; a risk analysis unit configured to analyze a risk of a change in an accumulated production volume at the analysis time in at least one industrial sector that is subject to analysis among the plurality of industrial sectors, based on the plurality of sample values stored in the sample storage unit; and an analysis result output unit configured to output an analysis result of the risk analysis unit.
(Appendix 2) The risk analysis system according to Appendix 1, wherein the sample generation unit is configured to, at each time up to the analysis time, apply an average production volume determined based on the input coefficients and production volumes of the plurality of industrial sectors at an immediately previous time to a function using a random number to generate a plurality of sample values of each industrial sector such that there is a variation in the plurality of sample values.
(Appendix 3) The risk analysis system according to Appendix 2, wherein the sample generation unit is configured to generate, at each time up to the analysis time, a value representing a variation in the production volume of each industrial sector, based on production volumes of the plurality of industrial sectors at an immediately previous time and a random number, and calculate a production volume of each industrial sector at each time based on the average production volume and the value representing the variation.
(Appendix 4) The risk analysis system according to any one of Appendices 1 to 3, further comprising: an analysis time acceptance unit configured to accept the analysis time; and an analysis time storage unit configured to store the accepted analysis time.
(Appendix 5) The risk analysis system according to any one of Appendices 1 to 4, further comprising an input-output table acceptance unit configured to accept input coefficients among the plurality of industrial sectors and store the input coefficients in the input-output table storage unit.
(Appendix 6) The risk analysis system according to any one of Appendices 1 to 5, wherein the risk analysis unit is configured to analyze a maximum value among the plurality of sample values of each industrial sector subjected to analysis as the risk.
(Appendix 7) The risk analysis system according to any one of Appendices 1 to 6, wherein the risk analysis unit is configured to analyze a minimum value among the plurality of sample values of each industrial sector subjected to analysis as the risk.
(Appendix 8) The risk analysis system according to any one of Appendices 1 to 7, wherein the risk analysis unit is configured to analyze the sample value of each industrial sector subjected to analysis as the risk, the sample value of each industrial sector corresponding to a maximum sample value of one industrial sector among the plurality of industrial sectors.
(Appendix 9) The risk analysis system according to any one of Appendices 1 to 8, wherein the risk analysis unit is configured to analyze the sample value of each industrial sector subjected to analysis as the risk, the sample value of each industrial sector corresponding to a minimum sample value of one industrial sector among the plurality of industrial sectors.
(Appendix 10) A risk analysis method comprising the steps of: storing input coefficients among a plurality of interdependent industrial sectors in an input-output table storage unit; storing an initial production volume of each industrial sector at an initial time in an initial production volume storage unit; generating a plurality of sample values of an accumulated production volume of each industrial sector from the initial time to a predetermined analysis time such that there is a variation in the plurality of sample values, based on the input coefficients and the initial production volumes; storing the plurality of generated sample values in a sample storage unit; analyzing a risk of a change in an accumulated production volume at the analysis time in at least one industrial sector that is subject to analysis among the plurality of industrial sectors, based on the plurality of sample values stored in the sample storage unit; and outputting an analysis result of the risk.
10 risk analysis system
20 input-output table acceptance unit
22 input-output table storage unit
24 initial production volume acceptance unit
26 initial production volume storage unit
28 analysis time acceptance unit
30 analysis time storage unit
32 production volume sample generation unit
34 accumulated production volume storage unit
36 production volume sample storage unit
38 risk analysis unit
40 analysis result output unit

1. A risk analysis system comprising:
an input-output table storage unit configured to store input coefficients among a plurality of interdependent industrial sectors;
an initial production volume storage unit configured to store an initial production volume of each industrial sector at an initial time;
a sample generation unit configured to generate a plurality of sample values of an accumulated production volume of each industrial sector from the initial time to a predetermined analysis time such that there is a variation in the plurality of sample values, based on the input coefficients and the initial production volumes;
a sample storage unit configured to store the plurality of sample values generated by the sample generation unit;
a risk analysis unit configured to analyze a risk of a change in an accumulated production volume at the analysis time in at least one industrial sector that is subject to analysis among the plurality of industrial sectors, based on the plurality of sample values stored in the sample storage unit; and
an analysis result output unit configured to output an analysis result of the risk analysis unit.

2. The risk analysis system according to claim 1, wherein
the sample generation unit is configured to, at each time up to the analysis time, apply an average production volume determined based on the input coefficients and production volumes of the plurality of industrial sectors at an immediately previous time to a function using a random number to generate a plurality of sample values of each industrial sector such that there is a variation in the plurality of sample values.

3. The risk analysis system according to claim 2, wherein
the sample generation unit configured to generate, at each time up to the analysis time, a value representing a variation in the production volume of each industrial sector, based on production volumes of the plurality of industrial sectors at an immediately previous time and a random number, and calculate a production volume of each industrial sector at each time based on the average production volume and the value representing the variation.

4. The risk analysis system according to claim 1, further comprising:
an analysis time acceptance unit configured to accept the analysis time and
an analysis time storage unit configured to store the accepted analysis time.

5. The risk analysis system according to claim 1, further comprising
an input-output table acceptance unit configured to accept input coefficients among the plurality of industrial sectors and store the input coefficients in the input-output table storage unit.

6. The risk analysis system according to claim 1, wherein
the risk analysis unit is configured to analyze a maximum value among the plurality of sample values of each industrial sector subjected to analysis as the risk.

7. The risk analysis system according to claim 1, wherein
the risk analysis unit is configured to analyze a minimum value among the plurality of sample values of each industrial sector subjected to analysis as the risk.

8. The risk analysis system according to claim 1, wherein
the risk analysis unit is configured to analyze the sample value of each industrial sector subjected to analysis as the risk, the sample value of each industrial sector corresponding to a maximum sample value of one industrial sector among the plurality of industrial sectors.

9. The risk analysis system according to claim 1, wherein
the risk analysis unit is configured to analyze the sample value of each industrial sector subjected to analysis as the risk, the sample value of each industrial sector corresponding to a minimum sample value of one industrial sector among the plurality of industrial sectors.

10. A risk analysis method comprising the steps of:
storing input coefficients among a plurality of interdependent industrial sectors in an input-output table storage unit;
storing an initial production volume of each industrial sector at an initial time in an initial production volume storage unit;
generating a plurality of sample values of an accumulated production volume of each industrial sector from the initial time to a predetermined analysis time such that there is a variation in the plurality of sample values, based on the input coefficients and the initial production volumes;
storing the plurality of generated sample values in a sample storage unit;
analyzing a risk of a change in an accumulated production volume at the analysis time in at least one industrial sector that is subject to analysis among the plurality of industrial sectors, based on the plurality of sample values stored in the sample storage unit; and
outputting an analysis result of the risk.
